(19) United States
(12) Patent Application Publication
(10) Pub. No.: US 2023/0106692 A1
(43) Pub. Date: Apr. 6, 2023

(54) REFLECTIVE SURFACE-BASED COMMUNICATIONS SYSTEM FOR RIDESHARE SERVICE VEHICLE

(71) Applicant: GM Cruise Holdings LLC, San Francisco, CA (US)

(72) Inventors: Aakanksha Mirdha, San Francisco, CA (US); Ajay Alfred, San Francisco, CA (US); Alexander Willem Gerrese, San Francisco, CA (US); Yifei Zhang, San Francisco, CA (US)

(73) Assignee: GM Cruise Holdings LLC, San Francisco, CA (US)

(21) Appl. No.: 17/495,485

(22) Filed: Oct. 6, 2021

(51) Int. Cl. B60K 35/00

(52) U.S. Cl. CPC B60K 35/00; B60K 2370/1533; B60K 2370/1868; B60K 2370/188; B60K 2370/191; B60K 2370/23; B60K 2370/797

(57) ABSTRACT

A method is described and includes identifying a reflection of an object in a reflective display element on an exterior of an autonomous vehicle (AV), wherein the object is associated with a driving event of the AV; and highlighting the reflection of the object on the at least one reflective display element.

### TECHNICAL FIELD OF THE DISCLOSURE

The present disclosure relates generally to rideshare services provided using autonomous vehicles (AVs) and, more specifically, to devices and methods for a reflective surface-based (RSB) communications system for AVs used in providing rideshare services.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts.

FIG. 1 is a block diagram illustrating an environment including an example AV in which aspects of an RSB communications system for AV rideshare services according to some embodiments of the present disclosure.

FIGS. 2A-2D illustrate an example AV that may include a RSB communications system according to some embodiments of the present disclosure.

FIGS. 3A, 3B, 4A, 4B, 5A and 5B illustrate several example use cases for the RSB communications system according to some embodiments of the present disclosure.

FIG. 6 is a block diagram illustrating an onboard computer for enabling aspects of an example RSB communications system for AV rideshare services according to some embodiments of the present disclosure.

FIG. 7 is a block diagram of a fleet management system for enabling aspects of an example RSB communications system for AV rideshare services according to some embodiments of the present disclosure.

FIG. 8 is a flowchart illustrating example processes of an RSB communications system for AV rideshare services according to some embodiments of the present disclosure.

### DESCRIPTION OF EXAMPLE EMBODIMENTS OF THE DISCLOSURE

Overview

The systems, methods, and devices of this disclosure each have several innovative aspects, no single one of which is solely responsible for all of the desirable attributes disclosed herein. Details of one or more implementations of the subject matter described in this Specification are set forth in the description below and the accompanying drawings.

Given the numerous advantages of rideshare and delivery services (which services may be collectively referred to herein simply as “rideshare services”) provided by AVs, it is anticipated that AV rideshare services will soon become the ubiquitous choice for various user transportation and delivery needs, including but not limited to school commutes, airport transfers, long distance road trips, and grocery and restaurant deliveries, to name a few. Currently, AVs are not particularly adept at communicating their intentions and upcoming actions to humans. This deficiency may result in confusion and/or discomfort for other on-road actors, including but not limited to pedestrians, cyclists, and drivers of other vehicles, since those actors may have little familiarity with AVs and have little to no information about what the AV “sees,” understands, and plans to do next. This situation is exacerbated by the expectation that typically ambiguities on the road may be resolved between human drivers using hand, eye, and/or head signals. With no human driver present in the AV for participation in such signaling, AVs need alternative ways of communicating their awareness of and intentions to human actors with whom they share the road.

Embodiments described herein include an RSB communications system for addressing the problem of poor-to-nonexistent communication between an AV and other on-road actors through use of a reflective (potentially mirror-based) material disposed on one or more exterior surfaces of the AV and augmented by digital annotations. In certain embodiments, portions of the AVs exterior are rendered highly reflective, potentially using a set of one-way mirrors or a reflective screen material, allowing those around the AV to view their own reflections in the reflective material.

A digital screen or projector enables annotations and overlays on the surface of the reflective material to communicate with the surrounding on-road actors. A variety of types of digital overlays or annotations may be used to help convey the AV's perception of its environment, as well as its intent and upcoming actions, including but not limited to “Acknowledgements,” “Signals,” and “Intents.”

In certain embodiments, Acknowledgements are digital annotations that may be superimposed onto the reflections of other on-road actors on the reflective material of the AV to convey to the actors that the AV perceives them and to instill trust that the AV will therefore react appropriately toward them. For example, a green checkmark and/or a “PEDESTRIAN” label may be overlaid on the reflection of a nearby pedestrian to convey to the pedestrian that the AV sees them and will yield as appropriate. Additionally and/or alternatively a green circle may be overlaid around the reflection of a bike of an adjacent cyclist to convey to the rider that the AV sees them and will not suddenly swerve and cut them off.

In certain embodiments, Signals are digital annotations including messages that help fill the gap of human-to-human signals by projecting images and/or messages toward other on-road actors who would benefit from input from the AV. For example, assuming four vehicles simultaneously arrive at a four-way stop and the AV would like to confirm that it will yield to the vehicle on its right, a yield icon with the message “YIELDING” may be projected toward the corresponding vehicle. In another example, assuming a pedestrian takes a step into the street to cross and stops to see if the AV will continue or stop, the AV may display a message informing the pedestrian to continue crossing the street and confirming that the AV will slow down and/or stop as necessary.

In certain embodiments, Intents are digital annotations including messages that indicate to other on-road actors what the AV will do next, including, for example, stopping, yielding, lane changes, turns, parking, and accelerating. For example, the AV may display a rearward-facing message indicating that it is “PULLING OVER” when it is about to double park in a lane to let a passenger out so that on-road actors behind the AV can prepare and respond accordingly. Additionally, the reflection of the physical space in front of the AV that will be occupied when the AV pulls over may also be annotated with an appropriate overlay. In another example, animated arrows moving in a certain direction may be projected onto the reflective surface of the AV to indicate that the AV is about to make a lane change in the indicated direction. In yet another example, a curved path may be overlaid on a reflection of the road on the AV to indicate where on the road the AV intends to make a turn.

In particular embodiments, digital annotations may be used to display on the reflective material on the exterior of the AV the number of vacant seats available in the AV. This feature may be useful in situations in which the AV is used in connection with a ride-hailing version of a ride sharing service. In other embodiments, the RSB communication system may be used to highlight and thereby deter bad actors associated with the AV. For example, if an unidentified person attempts to enter the AV, a message can be displayed on the reflective material on the exterior of the AV and a reflection of the bad actor can be annotated to indicate to the actor that the AV perceives and is recording them. In still other embodiments, the RSB communications system may be used to improve the passenger pickup process, for example, by identifying by the AV the passenger using image recognition and highlighting or annotating the reflection of the passenger on the reflective material on the exterior of the AV to indicate to the passenger that the AV is in fact the AV that has been dispatched to pick up the passenger.

Embodiments of the present disclosure provide a method including identifying a reflection of an object in a reflective display element on an exterior of an autonomous vehicle (AV), where the object is associated with a driving event of the AV; and highlighting the reflection of the object on the at least one reflective display element.

Embodiments of the present disclosure further provide a method including providing at least one reflective display element on an exterior surface of an autonomous vehicle (AV); identifying a location of an object associated with a driving event of the AV relative to the at least one reflective display element; identifying an image including a reflection of the identified object on the at least one reflective display element; and displaying a feature on the at least one reflective display element, where the feature is displayed in association with the image on the at least one reflective display element.

Embodiments of the present disclosure further provide an AV including a plurality of sensors for detecting and identifying an object; a reflective display element on an exterior surface of the AV; and a reflective-surface based (RSB) communications system module for locating a reflection of the object on the reflective display element using data from the plurality of sensors and displaying a feature for distinguishing the reflection of the object from reflections of other objects on the reflective display element.

As will be appreciated by one skilled in the art, aspects of the present disclosure, in particular aspects of an RSB communications system for AV rideshare services described herein, may be embodied in various manners (e.g., as a method, a system, an AV, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 110a-110e), such a collection may be referred to herein without the letters (e.g., as “110”).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y. The terms “substantially,” “close,” “approximately,” “near,” and “about,” generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

Example Environment for AV Rideshare Services Including RSB Communications System

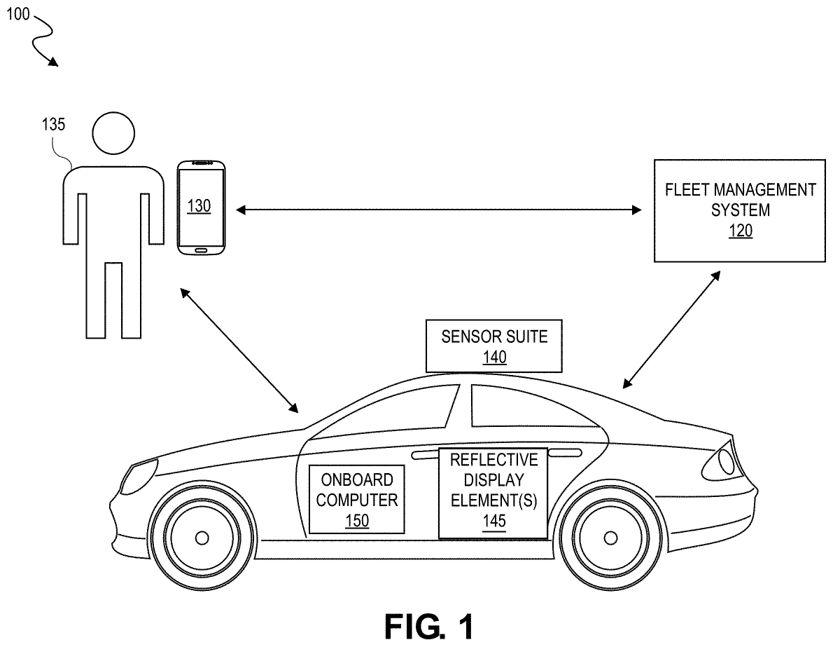

FIG. 1 is a block diagram illustrating an environment 100 including an AV 110 that can be used to provide rideshare services, which may include delivery services and ride-hail services, as well as human passenger transportation services, to a user according to some embodiments of the present disclosure. In particular, the environment 100 may comprise an RSB communications system, as will be described in greater detail below. The environment 100 includes an AV 110, a fleet management system 120, and a user device 130. The AV 110 may include a sensor suite 140, reflective display elements 145, and an onboard computer 150. The fleet management system 120 may manage a fleet of AVs that are similar to AV 110; one or more of the other AVs in the fleet may also include a sensor suite and onboard computer. The fleet management system 120 may receive service requests for the AVs 110 from user devices 130. For example, a user 135 may make a request for rideshare service using an application, or “app,” executing on the user device 130. The user device 130 may transmit the request directly to the fleet management system 120. In the case of a delivery service, the user device 130 may also transmit the request to a separate service (e.g., a service provided by a grocery store or restaurant) that coordinates with the fleet management system 120 to deliver orders to users. The fleet management system 120 dispatches the AV 110 to carry out the service requests. When the AV 110 arrives at a pickup location (i.e., the location at which the user is to meet the AV to begin the rideshare service or to retrieve his or her delivery order), the user may be notified by the app to meet the AV.

The AV 110 is preferably a fully autonomous automobile, but may additionally or alternatively be any semi-autonomous or fully autonomous vehicle; e.g., a boat, an unmanned aerial vehicle, a self-driving car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

The AV 110 includes a sensor suite 140, which may include a computer vision (“CV”) system, localization sensors, and driving sensors. For example, the sensor suite 140 may include photodetectors, cameras, Radio Detection and Ranging (RADAR), Light Detection and Ranging (LIDAR), Sound Navigation and Ranging (SONAR), Global Positioning System (GPS), wheel speed sensors, inertial measurement units (IMUS), accelerometers, microphones, strain gauges, pressure monitors, barometers, thermometers, altimeters, etc. The sensors may be located in various positions in and around the AV 110. For example, the sensor suite 140 may include multiple cameras mounted at different positions on the AV 110, including within the main cabin for passengers and/or deliveries.

The AV 110 further includes one or more reflective display elements 145 for use in implementing the RSB communications system, as described below. In various embodiments, the reflective display elements 145 may include one or more of a reflective surface and components for displaying, projecting, and/or overlaying text and/or images (simple or complex) on the reflective surface at a particular location (or “display coordinates”). Reflective display elements (also referred to herein as “reflective displays” or “reflective display material”) 145 may be disposed on one or more of opposite sides of the AV, as well as front and rear surfaces of the AV 110. In some embodiments, AV 110 may be “wrapped” in reflective display material, while in other embodiments, only select portions of the AV 110 may include reflective display elements 145. One or more reflective display elements 145 may be attached to or integrated into the exterior of the AV. One or more reflective display elements 145 may be flexible or rigid.

An onboard computer 150 may be connected to the sensor suite 140 and the reflective display elements 145 and functions to control the AV 110 and to process sensed data from the sensor suite 140 and/or other sensors in order to determine the state of the AV 110. Based upon the vehicle state and programmed instructions, the onboard computer 150 modifies or controls behavior of the AV 110. In addition, the onboard computer 150 controls various aspects of the operation and functionality of reflective display elements 145, including activating particular ones of the equipment as dictated by an application of the RSB communication system.

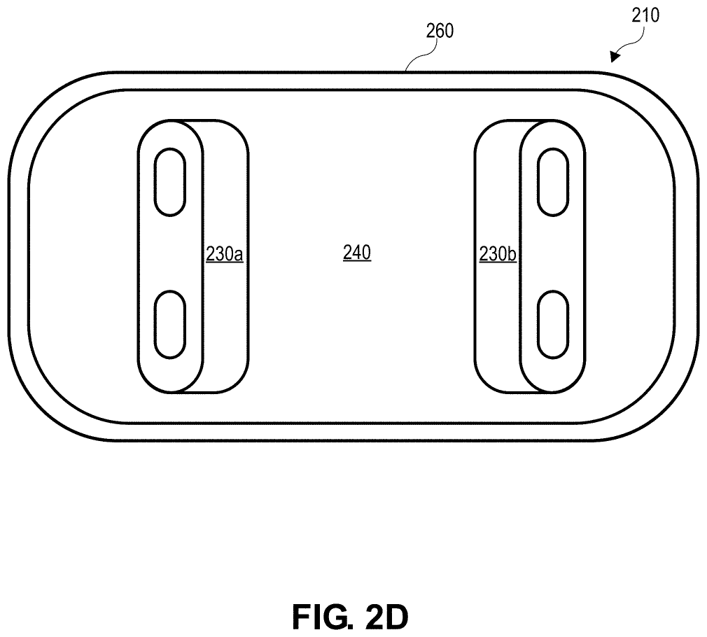

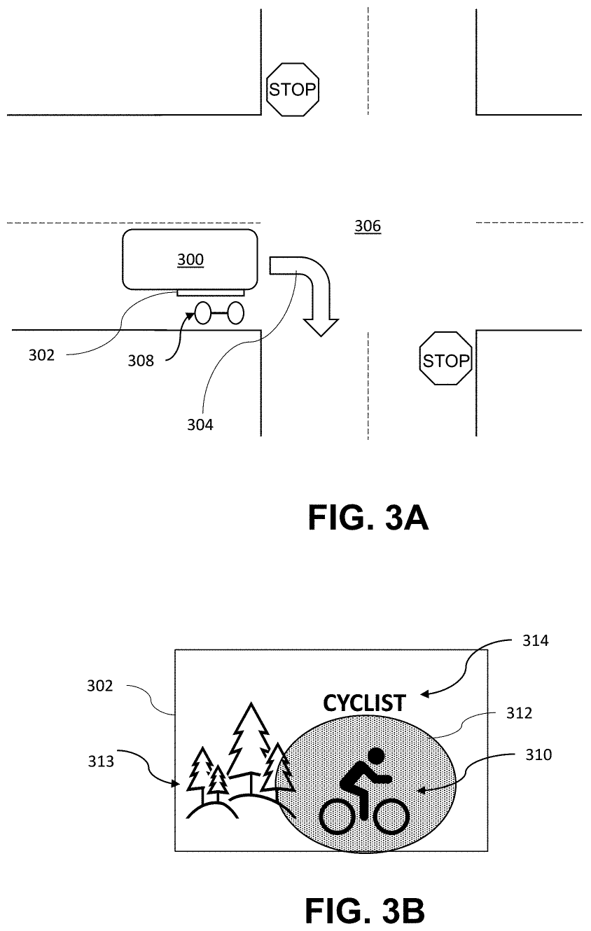

The onboard computer 150 is preferably a general-purpose computer adapted for I/O communication with vehicle control systems and sensor suite 140 but may additionally or alternatively be any suitable computing device. The onboard computer 150 is preferably connected to the Internet via a wireless connection (e.g., via a cellular data connection). Additionally and/or alternatively, the onboard computer 150 may be coupled to any number of wireless or wired communication systems. Aspects of the onboard computer 150 are described in greater detail with reference to FIG. 3.

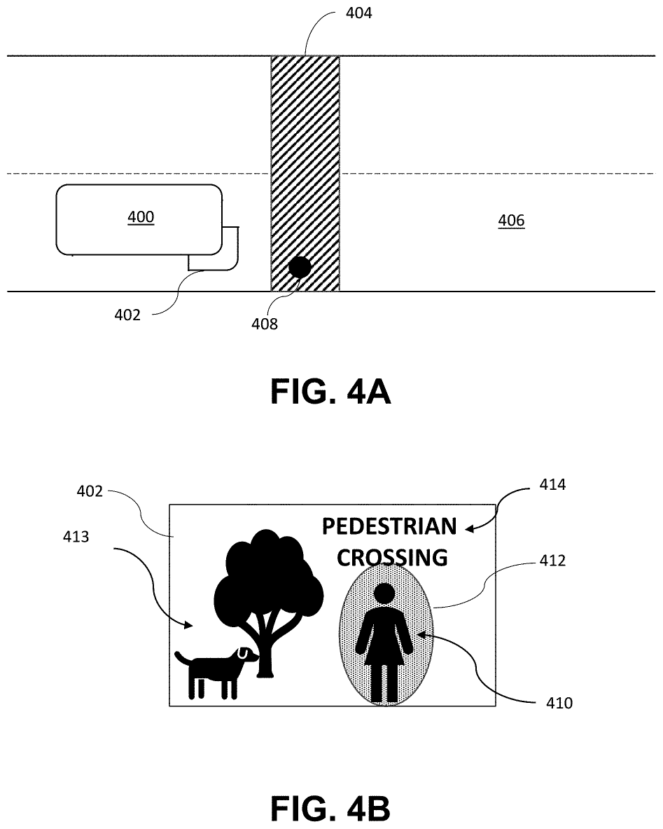

The fleet management system 120 manages the fleet of AVs, including AV 110. The fleet management system 120 may manage one or more services that provide or use the AVs, e.g., a service for providing rides to users with the AVs, or a service that delivers items, such as prepared foods, groceries, or packages, using the AVs. The fleet management system 120 may select an AV from the fleet of AVs to perform a particular service or other task and instruct the selected AV to autonomously drive to a particular location (e.g., a designated pickup location) to pick up a user and/or drop off an order to a user. The fleet management system 120 may select a route for the AV 110 to follow. The fleet management system 120 may also manage fleet maintenance tasks, such as charging, servicing, and cleaning of the AV. As shown in FIG. 1, the AV 110 communicates with the fleet management system 120. The AV 110 and fleet management system 120 may connect over a public network, such as the Internet. The fleet management system 120 is described in greater detail with reference to FIG. 4.

Example AV for Use in Connection with RSB Communications System

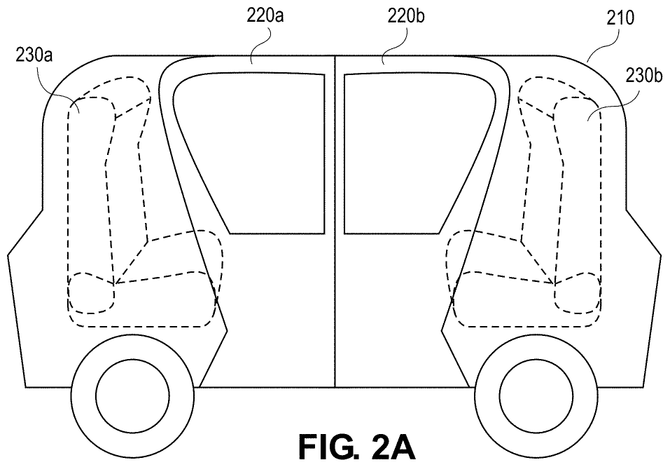

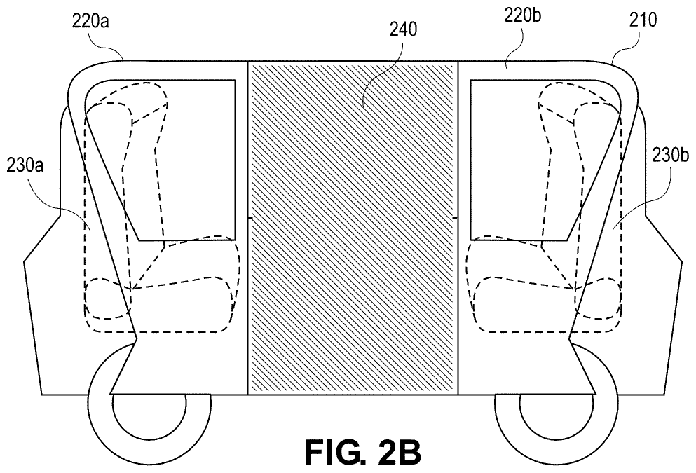

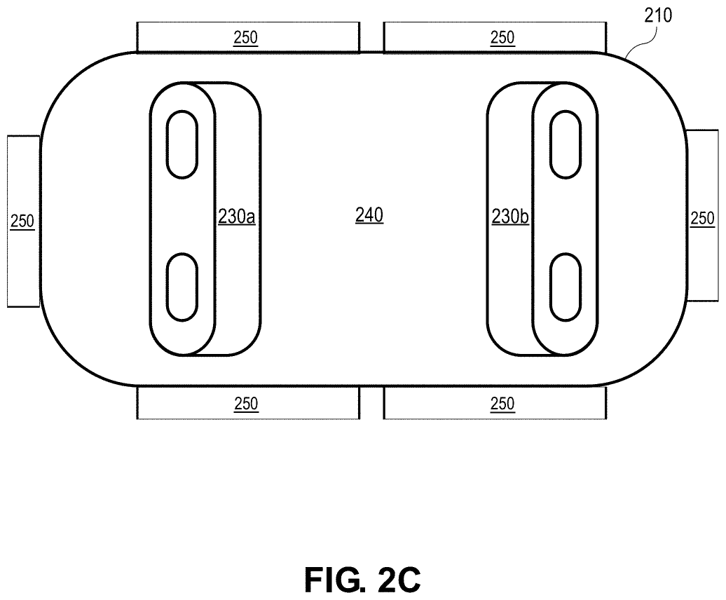

FIG. 2A illustrates an example AV 210, which is an example of the AV 110 described with respect to FIG. 1. The AV 210 includes two outer doors 220a and 220b along one side of the AV 210. In some embodiments, the AV 210 includes two similar doors on the side of AV opposite the side that includes the doors 220a and 220b. The doors 220a, 220b, provide access to an interior cabin of the AV 210, which may be used for passenger seating. In the embodiment illustrated in FIG. 2, the interior cabin includes two rows of seats 230a and 230b. The two rows of seats 230a and 230b are arranged facing each other with a gap in between the rows of seats 230.

To provide access to a main cabin of the AV 210, the left door 220a slides towards the left and the right door 220b slides to the right. FIG. 2B illustrates the AV 210 with its doors 220a and 220b open to allow access to the main cabin. A shaded area 240 between the seats 230a and 230b corresponds to a portion of the main cabin that is available to transport delivery items. The interior cabin of the AV 210 includes the passenger seats 230 and the area 240 between the seats.

FIGS. 2C and 2D illustrate an example “floor plan” of the AV 210 showing the area 240 between the seats 230a and 230b. In alternative embodiments, the AV 210 may have a different configuration, e.g., with seats in different positions, doors in different positions, doors opening in different ways, etc. In one example embodiment, as shown in FIG. 2C, AV 210 may include several reflective displays 250, which in certain embodiments comprise reflective display material, disposed on or integrated into one or more exterior surfaces of AV 210. In particular, as shown in FIG. 2C, reflective displays 250 are disposed on both sides and the front and the back of AV 210. In an alternative example embodiment, as shown in FIG. 2D, portions or all of AV 210 may be wrapped in reflective display material 260.

The displays 250/material 260 may be arranged on exterior surfaces of the AV 210 in consideration of where users/passengers will be situated relative to the AV so as to maximize visibility and effectiveness of the RSB communications system. Although specific arrangements of displays 250/material 260 are illustrated in FIGS. 2C and 2D, it will be recognized that other arrangements involving more or fewer displays 250/more or less material 260 may be implemented as desired or required for a particular application and/or as dictated by costs and/or other considerations.

Leaving the seats 230a and 230b in the AV 210 when the AV 210 is configured for delivery enables the fleet manager to switch the AV 210 between a passenger mode and a delivery mode more easily. Removing the seats 230a and 230b from the AV 210 may be cumbersome or may not be possible through the opening created by opening the doors 220a and 220b. Furthermore, repeated removal and reinstallation of the seats 230a and 230b may lead to increased wear and reduce their lifespan. In some cases, the seats 230a and 230b may be covered with a protective cover when the AV 210 is used for delivery.

Example Use Cases for RSB Communications System

FIGS. 3A, 3B, 4A, 4B, 5A and 5B several illustrate example use cases for the RSB communications system in accordance with embodiments described here. It will be recognized that the use cases illustrated in FIGS. 3A, 3B, 4A, 4B, 5A, and 5B are by no means exhaustive, but are offered merely to illustrate aspects of the RSB communications system described herein.

Referring first to FIG. 3A, illustrated therein is an example scenario in which an AV 300, which may be implemented using AV 110 (FIG. 1), includes at least one reflective display 302. In the example scenario illustrated in FIG. 3A, the AV 300 is planning to turn in a direction indicated by an arrow 304 (i.e., the AV 300 is planning to make a right turn) at an intersection 306. As shown in FIG. 3A, intersection 306 is a two-way stop and AV 300 does not have a stop sign. A cyclist 308 is traveling toward the intersection 306 and is located on the right of the AV 300. Because the AV 300 does not have a human driver, it may be unclear to the cyclist 308 whether the AV “sees” the cyclist. For example, if the cyclist 308 intends to proceed straight through the intersection 306, the cyclist may be concerned that the AV 300 may cut the cyclist off (or worse, collide with the cyclist) by turning right at the intersection. In accordance with some embodiments of the RSB communications system described herein, as shown in FIG. 3B, an image 310 of the cyclist 308 reflected on the reflective display 302 is highlighted 312 on the display to distinguish the reflected image 310 from other reflected images 313. Additionally and/or alternatively, an annotation (i.e., “CYCLIST”) 314 may be projected onto the reflective display 302 proximate the reflected image 310. As a result, the cyclist 308 may be assured that the AV 300 “sees” the cyclist and will respond appropriately (e.g., by yielding to the cyclist before turning right at the intersection 306).

In a similar manner, in an example scenario in which AV 300 has been dispatched to pick up a user, AV may identify the user using AV sensor data as well as profile information provided by the user and highlight an image of the user reflected in the reflective display 302 (similar to the manner in which the image 310 is highlighted 312) add an annotation (e.g., “WELCOME”) similar to the annotation 314 may be projected onto the reflective surface proximate the user's highlighted image to indicate to the user that the AV is the one assigned to the user.

Referring now to FIG. 4A, illustrated therein is an example scenario in which an AV 400, which may be implemented using AV 110 (FIG. 1), includes at least one reflective display 402. In the example scenario illustrated in FIG. 4A, the AV 400 is approaching a crosswalk 404 across a road 406 on which the AV is traveling. A pedestrian 408 is on the side of the road 406 waiting to cross via the crosswalk 404. Because the AV 400 does not have a human driver, it may be unclear to the pedestrian 408 whether the AV “sees” the pedestrian and/or crosswalk 404 and plans to stop at the crosswalk. In accordance with some embodiments of the RSB communications system described herein, as shown in FIG. 4B, an image 410 of the pedestrian 408 reflected on the reflective display 402 is highlighted 412 on the display to distinguish the reflected image 410 from other reflected images 413. Additionally and/or alternatively, an annotation (i.e., “PEDESTRIAN CROSSING”) 414 may be projected onto the reflective display 402 proximate the reflected image 410. As a result, the pedestrian 408 may be assured that the AV 400 “sees” the pedestrian 408 and will respond appropriately (e.g., by stopping at the crosswalk 404 to allow the pedestrian 408 to cross the road 406).

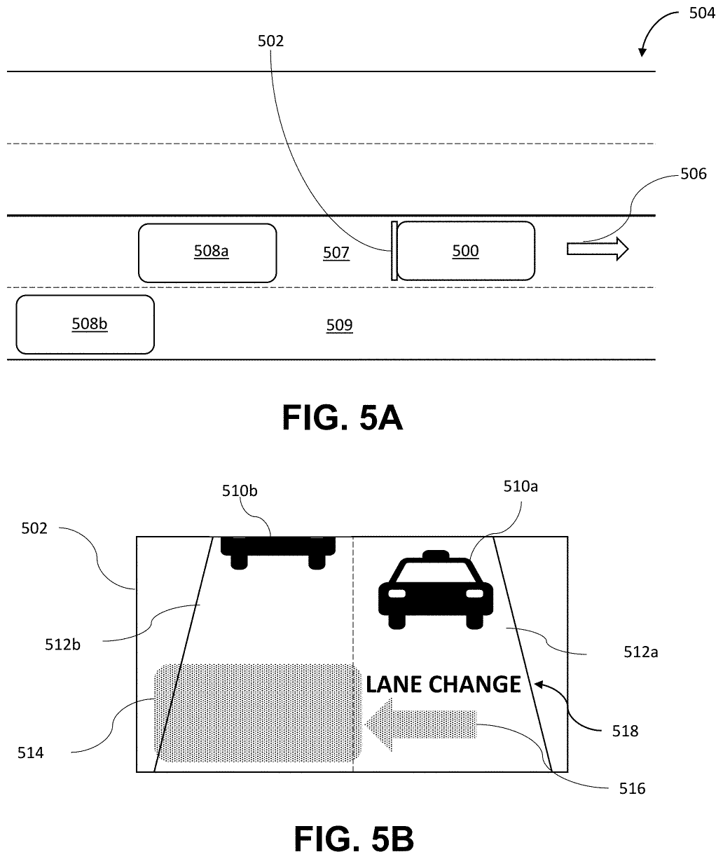

Referring now to FIG. 5A, illustrated therein is an example scenario in which an AV 500, which may be implemented using AV 110 (FIG. 1), includes at least one reflective display 502. In the example scenario illustrated in FIG. 5A, the AV 500 is traveling on a road 504 in a direction indicated by an arrow 506. As shown in FIG. 5A, AV 500 is in a first lane 507 of the road 504. Two other vehicles 508a, 508b, are also traveling on the road 504 behind the AV 500. The vehicle 508a is in the first lane 507 directly behind the AV 500. The vehicle 508b is in a second lane 509. It will be assumed for the sake of example that AV 500 intends to change lanes from the lane 507 to the lane 509.

In addition to signaling using the appropriate turn signal to indicate the AV's intent to change lanes, in accordance with some embodiments of the RSB communications system described herein, as shown in FIG. 5B, images 510a, 510b, of the vehicle 508a, 508b, as well as images 512a, 512b, of the lanes 507, 509, are reflected on the reflective display 502. A portion of the image 512b corresponding to a portion of the lane 509 into which the AV 500 is planning to move is highlighted 514 on the display 502 to provide a visual indication of the area in which the AV 500 is planning to move. Additionally and/or alternatively, one or more annotations comprising images (e.g., an arrow 516 indicating a direction in which the AV 500 intends to move) and/or text (i.e., a “LANE CHANGE” annotation 518) may be projected onto the reflective display 502 proximate the reflected images 510a, 510b, 512a, 512b. As a result, drivers of the vehicles 508a, 508b, are clearly apprised as to the intentions of the AV 500.

Example Onboard Computer

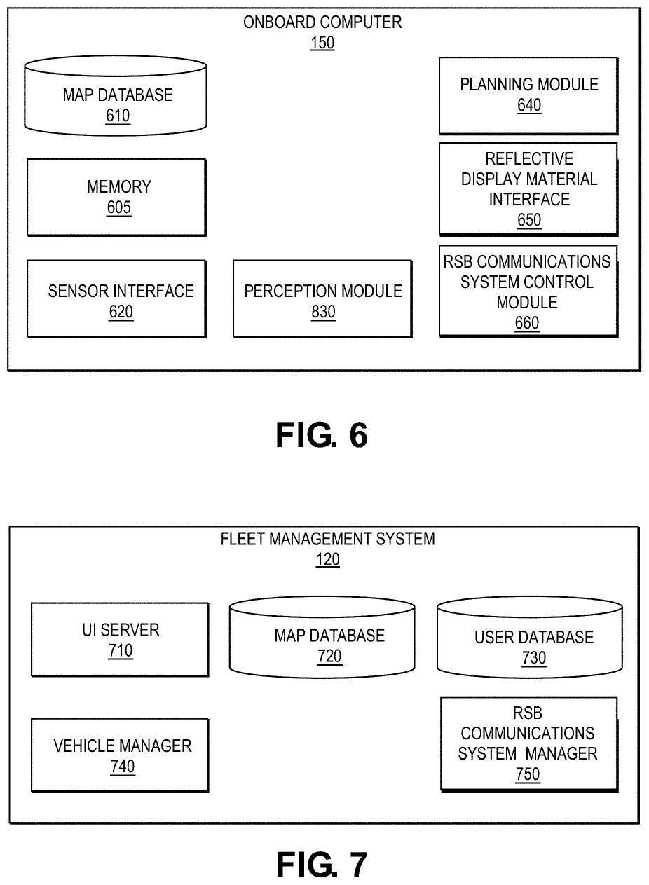

FIG. 6 is a block diagram illustrating onboard computer 150 for enabling features according to some embodiments of the present disclosure. The onboard computer 150 may include memory 605, a map database 610, a sensor interface 620, a perception module 630, a planning module 640, a reflective display material interface 650, and an RSB communications system control module 660. In alternative configurations, fewer, different and/or additional components may be included in the onboard computer 150. For example, components and modules for controlling movements of the AV 110 and other vehicle functions, and components and modules for communicating with other systems, such as the fleet management system 120 and exterior video conferencing systems, are not shown in FIG. 6. Further, functionality attributed to one component of the onboard computer 150 may be accomplished by a different component included in the onboard computer 150 or a different system from those illustrated.

The map database 610 stores a detailed map that includes a current environment of the AV 110. The map database 610 includes data describing roadways (e.g., locations of roadways, connections between roadways, roadway names, speed limits, traffic flow regulations, toll information, etc.) and data describing buildings (e.g., locations of buildings, building geometry, building types). The map database 610 may further include data describing other features, such as bike lanes, sidewalks, crosswalks, traffic lights, parking lots, etc.

The sensor interface 620 interfaces with the sensors in the sensor suite 140. The sensor interface 620 may request data from the sensor suite 140, e.g., by requesting that a sensor capture data in a particular direction or at a particular time. The sensor interface 620 is configured to receive data captured by sensors of the sensor suite 140. The sensor interface 620 may have subcomponents for interfacing with individual sensors or groups of sensors of the sensor suite 140, such as a thermal sensor interface, a camera interface, a lidar interface, a radar interface, a microphone interface, etc.

The perception module 630 identifies objects in the environment of the AV 110. The sensor suite 140 produces a data set that is processed by the perception module 630 to detect other cars, pedestrians, trees, bicycles, and objects traveling on or near a road on which the AV 110 is traveling or stopped, and indications surrounding the AV 110 (such as construction signs, traffic cones, traffic lights, stop indicators, and other street signs). For example, the data set from the sensor suite 140 may include images obtained by cameras, point clouds obtained by LIDAR sensors, and data collected by RADAR sensors. The perception module 630 may include one or more classifiers trained using machine learning to identify particular objects. For example, a multi-class classifier may be used to classify each object in the environment of the AV 110 as one of a set of potential objects, e.g., a vehicle, a pedestrian, or a cyclist. As another example, a human classifier recognizes humans in the environment of the AV 110, a vehicle classifier recognizes vehicles in the environment of the AV 110, etc.

The planning module 640 plans maneuvers for the AV 110 based on map data retrieved from the map database 610, data received from the perception module 630, and navigation information, e.g., a route instructed by the fleet management system 120. In some embodiments, the planning module 640 receives map data from the map database 610 describing known, relatively fixed features and objects in the environment of the AV 110. For example, the map data includes data describing roads as well as buildings, bus stations, trees, fences, sidewalks, etc. The planning module 640 receives data from the perception module 630 describing at least some of the features described by the map data in the environment of the AV 110. The planning module 640 determines a pathway for the AV 110 to follow. The pathway includes locations for the AV 110 to maneuver to, and timing and/or speed of the AV 110 in maneuvering to the locations.

The reflective display material interface 650 interfaces with the reflective display elements 145. The reflective display material interface 650 may request data from the sensor suite reflective display elements 145, e.g., by requesting that a camera capture data in a particular direction or at a particular time in order to capture an image of a particular person (e.g., a user, passenger, or third party) and/or by requesting a video conferencing session be moved from exterior equipment to interior equipment or vice versa. The reflective display material interface 650 is configured to receive data captured by individual components of the reflective display elements 145 (including displays 250 and/or materials 260), as well as to provide data to those components. The reflective display material interface 650 may have subcomponents for interfacing with individual components or groups of components of the reflective display elements 145.

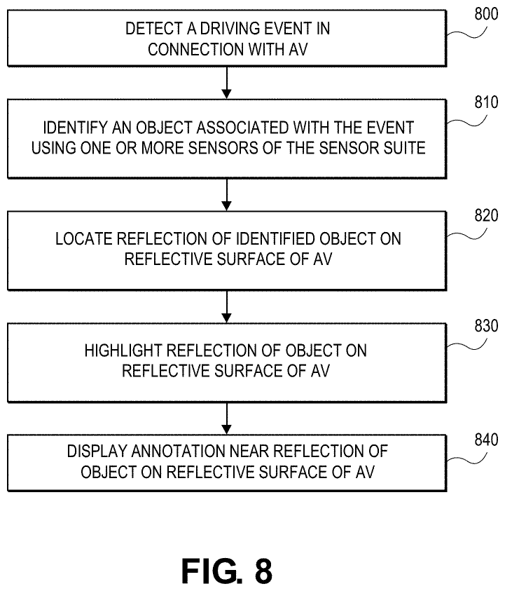

The RSB communications system control module 660 interacts with the reflective display material interface 650 to control and provide various aspects of the RSB communications system functionality described herein, including but not limited to features as described below with reference to FIG. 8.

Example Fleet Management System

FIG. 7 is a block diagram illustrating the fleet management system 120 according to some embodiments of the present disclosure. The fleet management system 120 includes a user interface (UI) server 710, a map database 720, a user database 730, a vehicle manager 740, and an RSB communications system manager 750. In alternative configurations, different, additional, or fewer components may be included in the fleet management system 120. Further, functionality attributed to one component of the fleet management system 120 may be accomplished by a different component included in the fleet management system 120 or a different system than those illustrated.

The UI server 710 is configured to communicate with client devices that provide a user interface to users. For example, the UI server 710 may be a web server that provides a browser-based application to client devices, or the UI server 710 may be a user app server that interfaces with a user app installed on client devices, such as the user device 130. The UI enables the user to access a service of the fleet management system 120, e.g., to request a ride from an AV 110, or to request a delivery from an AV 110. For example, the UI server 710 receives a request for a ride that includes an origin location (e.g., the user's current location) and a destination location, or a request for a delivery that includes a pickup location (e.g., a local restaurant) and a destination location (e.g., the user's home address). In accordance with features of embodiments described herein, UI server 710 may communicate information to a user regarding various aspects of the RSB communications system functionality, including but not limited to supporting functionality for initiating features of RSB communications system functionality as described below with reference to FIG. 8.

The map database 720 stores a detailed map describing roads and other areas (e.g., parking lots, AV service facilities) traversed by the fleet of AVs 110. The map database 720 includes data describing roadways (e.g., locations of roadways, connections between roadways, roadway names, speed limits, traffic flow regulations, toll information, etc.), data describing buildings (e.g., locations of buildings, building geometry, building types), and data describing other objects (e.g., location, geometry, object type), and data describing other features, such as bike lanes, sidewalks, crosswalks, traffic lights, parking lots, etc. At least a portion of the data stored in the map database 720 is provided to the AVs 110 as a map database 610, described above.

The user database 730 stores data describing users of the fleet of AVs 110. Users may create accounts with the fleet management system 120, which stores user information associated with the user accounts, or user profiles, in the user database 730. The user information may include identifying information (name, username), password, payment information, home address, contact information (e.g., email and telephone number), and information for verifying the user (e.g., photograph, driver's license number). Users may provide some or all of the user information, including user preferences regarding certain aspects of services provided by the rideshare system, to the fleet management system 120. In some embodiments, the fleet management system 120 may infer some user information from usage data or obtain user information from other sources, such as public databases or licensed data sources.

The fleet management system 120 may learn one or more home addresses for a user based on various data sources and user interactions. The user may provide a home address when setting up his account, e.g., the user may input a home address, or the user may provide an address in conjunction with credit card information. In some cases, the user may have more than one home, or the user may not provide a home address, or the user-provided home address may not be correct (e.g., if the user moves and the home address is out of date, or if the user's address associated with the credit card information is not the user's home address). In such cases, the fleet management system 120 may obtain a home address from one or more alternate sources. In one example, the fleet management system 120 obtains an address associated with an official record related to a user, such as a record from a state licensing agency (e.g., an address on the user's driver's license), an address from the postal service, an address associated with a phone record, or other publicly available or licensed records. In another example, the fleet management system 120 infers a home address based on the user's use of a service provided by the fleet management system 120. For example, the fleet management system 120 identifies an address associated with at least a threshold number of previous rides provided to a user (e.g., at least 10 rides, at least 50% of rides, or a plurality of rides), or at least a threshold number of previous deliveries (e.g., at least five deliveries, at least 60% of deliveries) as a home address or candidate home address. The fleet management system 120 may look up a candidate home address in the map database 720 to determine if the candidate home address is associated with a residential building type, e.g., a single-family home, a condominium, or an apartment. The fleet management system 120 stores the identified home address in the user database 730. The fleet management system 120 may obtain or identify multiple addresses for a user and associate each address with the user in the user database 730. In some embodiments, the fleet management system 120 identifies a current home address from multiple candidate home addresses, e.g., the most recent address, or an address that the user rides to or from most frequently and flags the identified current home address in the user database 730.

The vehicle manager 740 directs the movements of the AVs 110 in the fleet. The vehicle manager 740 receives service requests from users from the UI server 710, and the vehicle manager 740 assigns service requests to individual AVs 110. For example, in response to a user request for transportation from an origin location to a destination location, the vehicle manager 740 selects an AV and instructs the AV to drive to the origin location (e.g., a passenger or delivery pickup location), and then instructs the AV to drive to the destination location (e.g., the passenger or delivery destination location). In addition, the vehicle manager 740 may instruct AVs 110 to drive to other locations while not servicing a user, e.g., to improve geographic distribution of the fleet, to anticipate demand at particular locations, to drive to a charging station for charging, etc. The vehicle manager 740 also instructs AVs 110 to return to AV facilities for recharging, maintenance, or storage.

The RSB communications system manager 750 manages various aspects of RSB communications system functionality with respect to a fleet of AVs, including but not limited to various features as described below with reference to FIG. 8.

Example Methods for RSB Communications System Implementation and Operation

FIG. 8 are flowcharts illustrating example processes for an RSB communications system for an AV rideshare service according to some embodiments of the present disclosure. One or more of the steps illustrated in FIG. 8 may be executed by one or more of the elements shown in FIGS. 6 and 7.

FIG. 8 is a flowchart illustrating an example operation of the RSB communications system in accordance with embodiments described herein.

In step 800, a driving event in connection with the AV is detected, perceived, identified, determined and/or sensed. A driving event may include but is not limited to detection of a road actor next to the AV, arrival at a pickup location to pick up a user or an item for delivery, detection of a pedestrian near or in a crosswalk, determination that the AV intends to change lanes, etc. In general, a “driving event” as used herein is any event in connection with which the AV may need to communicate with another on-road actor using the RSB communication system.

In step 810, one or more objects associated with the AV driving event is identified. In the context of this disclosure, an object may include, but is not limited to an on-road actor, such as a pedestrian, a cyclist, a driver of another vehicle, a parked vehicle, a moving vehicle, a portion of the road the AV is traversing (e.g., on either side, in front of, or behind the AV), and an area alongside the road the AV is traversing (e.g., a sidewalk or bike path). In accordance with features of embodiments described herein, the at least one object is identified using data from one or more sensors of the AV sensor suite.

In step 820, a reflection of the object identified in step 810 on the reflective surface of the AV is located. In certain embodiments, sensor data is processed to determine a location of the identified object relative to the AV and a corresponding location of the reflected image of the identified object on the reflective display element(s). In certain embodiments, map data, user profile information and/or other data may also be used to identify an object (step 810) and/or a location of the object (step 820).

In step 830, the reflected image of the object located in step 820 may be highlighted. For example, in certain embodiments, a designated color (e.g., green) may be overlaid on the reflected image. In other embodiments, a sign (e.g., a check mark) may be overlaid on the reflected image or an indicator (e.g., a circle) may be overlaid around the reflected image. In general, any manner of highlighting that draws attention to the reflected image of the identified object, as opposed to/distinguished from other reflected images on the reflective display element, may be used.

In step 840, an annotation may be displayed on the reflective surface proximate or otherwise in connection with the reflected image of the identified object. In certain situations, the annotation may be a label identifying the road-actor (e.g., “CYCLIST,” “USER,” “PEDESTRIAN”). In other situations, the annotation may convey information regarding the intent of the AV (e.g., “TURNING RIGHT,” “PULLING OVER”). In still other situations, the annotation may merely include a message (e.g., “WELCOME,” “TWO SPOTS AVAILABLE”). In certain embodiments, the annotation may include one or more of text and images for communicating information to other road-actors. Such images may be static, dynamic, animated, simple and/or complex.

In certain embodiments, either one of steps 830 and 840 may be optional, with only a highlight or an annotation being displayed on the reflective surface in connection with the reflection of the object.

Although the operations of the example method shown in FIG. 8 are illustrated as occurring once each and in a particular order, it will be recognized that the operations may be performed in any suitable order and repeated as desired. Additionally, one or more operations may be performed in parallel. Furthermore, the operations illustrated in FIG. 8 may be combined or may include more or fewer details than described.

### SELECT EXAMPLES

Example 1 provides a method including identifying a reflection of an object in a reflective display element on an exterior of an autonomous vehicle (AV), where the object is associated with a driving event of the AV; and highlighting the reflection of the object on the at least one reflective display element.

Example 2 provides the method of example 1, further including displaying an annotation associated with the reflection of the object on the at least one reflective display element.

Example 3 provides the method of example 2, where the annotation includes at least one of text that identifies the object; text that communicates information regarding the driving event to a third party outside the AV; and an image that communicates information regarding the driving event to a third party outside the AV.

Example 4 provides the method of any of examples 1-3, where the highlighting further includes at least one of displaying a shape around the reflection of the object; displaying a symbol on the reflection of the object; and displaying selected color on an area of the at least one reflective display element surrounding the reflection of the object.

Example 5 provides the method of any of examples 1-4, where the object includes at least one of a pedestrian, a cyclist, a vehicle, a portion of a road on which the AV is located, and a portion of an area alongside the road.

Example 6 provides the method of any of examples 1-5, further including, determining a location of the object relative to the reflective display element.

Example 7 provides the method of example 6, where the determining is performed using data provided by a plurality of on-board sensors of the AV.

Example 8 provides the method of example 7, where the identifying a reflection is performed using the location of the object relative to the reflective display element and data provided by the plurality of on-board sensors of the AV.

Example 9 provides the method of any of examples 1-8, where the at least one reflective display element includes a plurality of display elements on front, a rear, and opposite sides of the AV.

Example 10 a method including providing at least one reflective display element on an exterior surface of an autonomous vehicle (AV); identifying a location of an object associated with a driving event of the AV relative to the at least one reflective display element; identifying an image including a reflection of the identified object on the at least one reflective display element; and displaying a feature on the at least one reflective display element, where the feature is displayed in association with the image on the at least one reflective display element.

Example 11 provides the method of example 10, where the displaying includes at least one of highlighting the image and annotating the image.

Example 12 provides the method of example 11, where the annotating further includes at least one of displaying on the reflective display element text that indicates an identity of the object; text that communicates information regarding the driving event to a third party outside the AV; and an image that communicates information regarding the driving event to a third party outside the AV.

Example 13 provides the method of any of examples 11-12, where the highlighting further includes at least one of displaying a shape around the image; displaying a symbol on the image; and displaying selected color on an area of the at least one reflective display element surrounding the image.

Example 14 provides the method of any of examples 11-13, where the feature distinguishes the image from other objects reflected on the reflective display element.

Example 15 provides the method of any of examples 10-14, where the object includes at least one of a pedestrian, a cyclist, a vehicle, a portion of a road on which the AV is located, and a portion of an area alongside the road.

Example 16 provides an AV including a plurality of sensors for detecting and identifying an object; a reflective display element on an exterior surface of the AV; and a reflective-surface based (RSB) communications system module for locating a reflection of the object on the reflective display element using data from the plurality of sensors and displaying a feature for distinguishing the reflection of the object from reflections of other objects on the reflective display element.

Example 17 provides the AV of example 16, where the reflective display element includes a plurality of reflective display elements.

Example 18 provides the AV of any of examples 16-17, where the reflective display element is flexible.

Example 19 provides the AV of any of examples 16-18, where the displaying further includes at least one of displaying on the reflective display element text that indicates an identity of the object; text that communicates information regarding the driving event to a third party outside the AV; and an image that communicates information regarding the driving event to a third party outside the AV.

Example 20 provides the AV of any of examples 16-19, where the displaying further includes at least one of displaying a shape around the image; displaying a symbol on the image; and displaying selected color on an area of the at least one reflective display element surrounding the image.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words “means for” or “step for” are specifically used in the particular examples; and (b) does not intend, by any statement in the Specification, to limit this disclosure in any way that is not otherwise reflected in the appended examples.

What is claimed is:

1. A method comprising:
identifying a reflection of an object in a reflective display element on an exterior of an autonomous vehicle (AV), wherein the object is associated with a driving event of the AV; and
highlighting the reflection of the object on the at least one reflective display element.

2. The method of claim 1, further comprising displaying an annotation associated with the reflection of the object on the at least one reflective display element.

3. The method of claim 2, wherein the annotation comprises at least one of:
text that identifies the object;
text that communicates information regarding the driving event to a third party outside the AV; and
an image that communicates information regarding the driving event to a third party outside the AV.

4. The method of claim 1, wherein the highlighting further comprises at least one of:
displaying a shape around the reflection of the object;
displaying a symbol on the reflection of the object; and
displaying selected color on an area of the at least one reflective display element surrounding the reflection of the object.

5. The method of claim 1, wherein the object comprises at least one of a pedestrian, a cyclist, a vehicle, a portion of a road on which the AV is located, and a portion of an area alongside the road.

6. The method of claim 1, further comprising, determining a location of the object relative to the reflective display element.

7. The method of claim 6, wherein the determining is performed using data provided by a plurality of on-board sensors of the AV.

8. The method of claim 7, wherein the identifying a reflection is performed using the location of the object relative to the reflective display element and data provided by the plurality of on-board sensors of the AV.

9. The method of claim 1, wherein the at least one reflective display element comprises a plurality of display elements on front, a rear, and opposite sides of the AV.

10. A method comprising:
providing at least one reflective display element on an exterior surface of an autonomous vehicle (AV);
identifying a location of an object associated with a driving event of the AV relative to the at least one reflective display element;
identifying an image comprising a reflection of the identified object on the at least one reflective display element; and
displaying a feature on the at least one reflective display element, wherein the feature is displayed in association with the image on the at least one reflective display element.

11. The method of claim 10, wherein the displaying comprises at least one of highlighting the image and annotating the image.

12. The method of claim 11, wherein the annotating further comprises at least one of displaying on the reflective display element:
text that indicates an identity of the object;
text that communicates information regarding the driving event to a third party outside the AV; and
an image that communicates information regarding the driving event to a third party outside the AV.

13. The method of claim 11, wherein the highlighting further comprises at least one of:
displaying a shape around the image;
displaying a symbol on the image; and
displaying selected color on an area of the at least one reflective display element surrounding the image.

14. The method of claim 11, wherein the feature distinguishes the image from other objects reflected on the reflective display element.

15. The method of claim 11, wherein the object comprises at least one of a pedestrian, a cyclist, a vehicle, a portion of a road on which the AV is located, and a portion of an area alongside the road.

16. An autonomous vehicle (AV) comprising:
a plurality of sensors for detecting and identifying an object;
a reflective display element on an exterior surface of the AV; and
a reflective-surface based (RSB) communications system module for locating a reflection of the object on the reflective display element using data from the plurality of sensors and displaying a feature for distinguishing the reflection of the object from reflections of other objects on the reflective display element.

17. The AV of claim 16 of claim 17, wherein the reflective display element comprises a plurality of reflective display elements.

18. The AV of claim 16, wherein the reflective display element is flexible.

19. The AV of claim 16, wherein the displaying further comprises at least one of displaying on the reflective display element:
text that indicates an identity of the object;
text that communicates information regarding the driving event to a third party outside the AV; and
an image that communicates information regarding the driving event to a third party outside the AV.

20. The AV of claim 16, wherein the displaying further comprises at least one of:
displaying a shape around the image;
displaying a symbol on the image; and
displaying selected color on an area of the at least one reflective display element surrounding the image.
